(19) United States
(12) Patent Application Publication
(10) Pub. No.: US 2017/0058154 A1
(43) Pub. Date: Mar. 2, 2017

(54) Filter to Prepare Low Molecular Weight Polymers for Adhesive Compositions

(71) Applicant: ExxonMobil Chemical Patents Inc., Baytown, TX (US)

(72) Inventors: Aaron H. Reed, Zachary, LA (US); Douglas A. Berti, Houston, TX (US); Kyle B. Hancock, Houston, TX (US)

(21) Appl. No.: 15/204,511

(22) Filed: Jul. 7, 2016

Related U.S. Application Data
(60) Provisional application No. 62/212,044, filed on Aug. 31, 2015.

(30) Foreign Application Priority Data
Oct. 23, 2015 (EP) 15191166.6

(51) Int. Cl. C09J 123/14; C08L 23/14

(52) U.S. Cl. CPC C09J 123/142; C08L 23/142

(57) ABSTRACT

This invention relates to a process for producing a low molecular weight polyolefin adhesive component, the process including the steps of (a) cooling a polymer solution to a temperature less than or equal to about its cloud point to form a cooled polymer solution; (2) filtering the cooled polymer solution using a filter, wherein the polymer solution includes a low molecular weight polyolefin adhesive component and a solvent; and (b) recovering the solvent and the polyolefin.

### PRIORITY

This invention claims priority to and the benefit of U.S. Patent Application Ser. No. 62/212,044, filed Aug. 31, 2015, and European Patent Application No. 15191166.6 filed Oct. 23, 2015, both of which are herein incorporated by reference.

### FIELD

This invention relates to a filter to prepare low molecular weight polymers for adhesive compositions, and a process related thereof.

### BACKGROUND

A number of processes exist for producing polymers of varying molecular weight. One example of a polymerization process that can be used in the production of, inter alia, olefin based polymers (e.g., polyethylene and polypropylene) is continuous solution based polymerization. The continuous solution polymerization generally involves the addition of a catalyst to a monomer and optionally a solvent mixture. Upon reaction, the formed polymer is dissolved in the polymerization medium or solvent, often along with any catalyst and unreacted monomer, frequently with the solution exiting the reactor having a relatively low polymer concentration, such as from about 3 wt % to 30 wt %. The product mixture is then passed to polymer concentration and finishing stages to separate the solvent and unreacted monomer from the mixture such that the desired polymer can be recovered in a usable form. The separated solvent and monomer can then later be recycled back to the reactor for re-use.

U.S. Patent Publication No. 2015/073106 discloses a flexible process and production plant to accommodate the processing of both low molecular weight and high-molecular weight polymers in the same plant and using the same separation system, using a lower critical solution temperature (LCST) process and/or flash vaporization. However, during the polymer separation process, LCST or flash vaporization may be unable to provide a clean separation between the polymer product and the solvent. Because of this, a significant fraction of the polymer product is carried overhead in the lean phase, where it can plate out and detrimentally foul equipment in the recycle solvent stream.

Accordingly, the inventors have discovered that incorporating a filter into the polymerization process can be used to precipitate polymer from solvent and therefore reduce fouling in the internal components of the polymerization process.

### SUMMARY

In one aspect, the invention resides in a process for producing a low molecular weight polyolefin adhesive component, the process comprising the steps of (a) cooling a polymer solution to a temperature less than or equal to about its cloud point; (b) filtering the cooled polymer solution using a filter, wherein the polymer solution comprises a low molecular weight polyolefin adhesive component and a solvent; and (c) recovering the solvent and the polyolefin.

### BRIEF DESCRIPTION OF THE DRAWING

FIG. 1 is a schematic representation of the filter according to one embodiment of the invention.

### DETAILED DESCRIPTION OF THE EMBODIMENTS

Described herein is a system for separating polymer from solvent in a process for preparing low molecular weight polymers for adhesive compositions.

In a conventional metallocene-catalyzed, solution-based process for polymerizing olefinic monomers, such as ethylene, propylene, and/or other a-olefins, the product effluent exiting the polymerization reactor is a dilute solution of the desired polymer (typically 3 wt % to 30 wt %) in the polymerization solvent. The effluent solution may also contain significant quantities of unreacted monomer. In order to recover the polymer so that it can be made into useable form for sale, essentially all the solvent and unreacted monomer must be removed. In addition, to ensure sound process economics, as much as possible of the solvent and unreacted monomer must be recycled back to the polymerization reactor.

As disclosed in International Publication No. WO2013/134038, incorporated herein by reference, the liquid-phase separator may operate on the principle of Lower Critical Solution Temperature (LCST) phase separation. This technique uses the thermodynamic principle of spinodal decomposition to generate two liquid phases; one substantially free of polymer and the other containing the dissolved polymer at a higher concentration than the single liquid feed to the liquid-phase separation vessel. The liquid phase substantially free of polymer is carried overhead, where it may detrimentally foul internal equipment.

In the case of low molecular weight polymers, effecting polymer recovery by the LCST process often fails to achieve a clean separation between the polymer and the solvent. As a result, a significant fraction of the polymer can be carried overhead in the polymer-lean phase where it may foul equipment in the recycle solvent system. Thus, with low-molecular weight polymers, it is normally necessary to remove the solvent by flash separation which, although less energy efficient than LCST, reduces the chance any of the low-molecular weight polymer from solubilizing and being carried over in the vapor stream into the recycle solvent system. However, even with flash separation, there may be polymer carried overhead and hence fouling of internal equipment.

### Polymerization Process Incorporating a Filter

The present process and system incorporates a filter into the polymerization process to reduce fouling of internal components from the accumulation of polymer product in the overhead line.

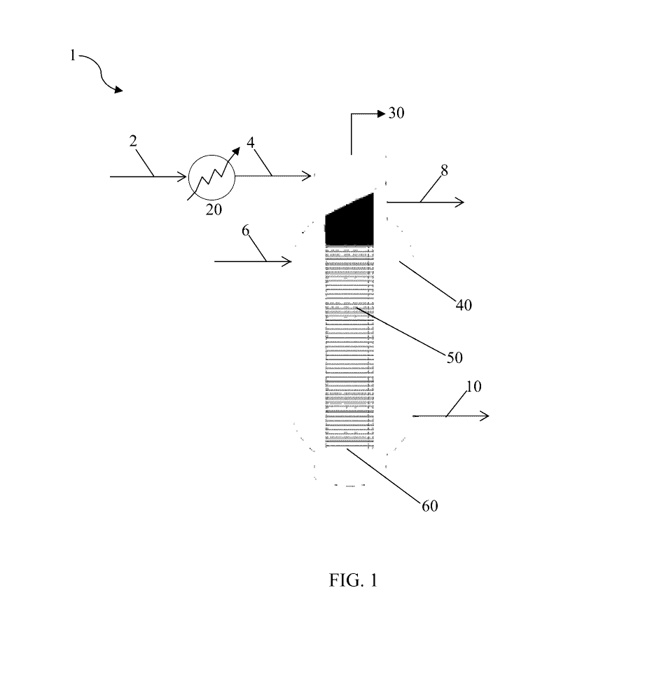

Referring to FIG. 1, in one embodiment of the invention, the filter system 1 is incorporated in the polymerization process to reduce fouling caused by the accumulation of polymer in the overhead stream. Polymer solution 2, including polymer and solvent, is fed to a heat exchanger 20 to cool the polymer solution 2 to a temperature at or below its cloud point, thereby forming a cooled polymer solution 4.

The polymer solution has a cloud point of greater than about −50° C. or about −40° C. or about −30° C. or about −20° C. or about −10° C. or about −5° C. or about 0° C. to less than about 5° C. or about 10° C. or about 20° C. or about 30° C. or about 40° C. In an embodiment, the solvent of the polymer solution is either isohexane or n-hexane. “Cloud Point” of the polymer solution is the temperature at which the polymer solution, dissolved in particular solvent, is no longer completely soluble (as determined by a cloudy appearance of the polymer solution/solvent mixture). The Cloud Point of the present invention was determined using a modified ASTM D-611-82 method, substituting methylcyclohexane for the heptane used in the standard test procedure. The procedure used polymer solution/aniline/methycyclohexane in a ratio of about 1/2/1 (5 g/10 mL/5 mL). The Cloud Point was determined by cooling a heated, clear blend of the three components until a complete turbidity occurs.

It is appreciated that heat exchanger 20 can be any heat exchanger used to cool a fluid known in the art. In an embodiment, heat exchanger 20 is a shell and tube exchanger, where the polymer solution 2 enters on the tube side and a cooling medium, such as propylene, enters on the shell side, thereby cooling the polymer solution 2 to a temperature at or below its cloud point when it exits the heat exchanger 20 as cooled polymer solution 4.

The cooled polymer solution 4 and cooling medium 6 enter the filter 60. In an embodiment, the cooling medium is propylene, ethylene, glycol, or freon. The cooling medium is at a temperature of greater than or equal to about −28° C. or about −20° C. or about −15° C. or about −10° C. or about −5° C. to less than about 0° C. or about 5° C. or about 10° C. The filter 60 includes a jacket 40 and a basket 50, preferably having a nylon filter sock with openings in the range of about 1 to about 10 microns. The filter 60 precipitates the polymer from the solvent, where the polymer accumulates in the filter basket 50 and can be removed from the top of the filter via line 30, and the solvent free of polymer exits the filter 60 via line 8. Cooling medium 6 exits the filter 60 at stream 10. The cooling medium helps maintain the low temperature of the cooled polymer solution over the filter 60 to maximize the polymer recovery from the polymer solution. There is no appreciable temperature drop over the filter 60.

### Low Molecular Weight Polyolefin for Use as an Adhesive Component

The low molecular polyolefin prepared according to the process described herein, and system thereof, may be suitable for use in an adhesive composition. Specifically, the polyolefin may be incorporated by itself or blended with one or more additional polyolefins and one or more additional adhesive components. The one or more additional polyolefins may be similar to the polyolefin prepared herein, or may be selected from one or more of the following: ethylene vinyl acetates, ethylene acrylates, block copolymers, propylene homopolymers, ethylene homopolymers, and amorphous poly-alpha olefins.

In an embodiment, the polyolefin has a weight average molecular weight (Mw) less than about 200,000 g/mol or about 150,000 g/mol or about 90,000 g/mol or about 75,000 g/mol or about 50,000 g/mol to greater than about 1,000 g/mol or about 2,500 g/mol or about 5,000 g/mol or about 7,500 g/mol or about 10,000 g/mol or about 25,000 g/mol. Mw is characterized using a High Temperature Size Exclusion Chromatograph (SEC), equipped with a differential refractive index detector (DRI), an online light scattering detector (LS), and a viscometer. Experimental details not shown below, including how the detectors are calibrated, are described in T. Sun, P. Brant, R. R. Chance, and W. W. Graessley, Macromolecules, Volume 34, Number 19, pp. 6812-6820, 2001, and International Patent Publication No. WO2013/134038, incorporated herein by reference.

In an embodiment, the polyolefin has a melt viscosity of greater than or equal to about 80 cP or about 100 cP or about 150 cP to less than about 500 cP or about 400 cP or about 300 cP or about 200 cP. Melt viscosity is measured at 175° C. according to ASTM D-3236.

### Additives for Adhesive Compositions

The adhesive composition can include other adhesive components/additives, e.g., tackifiers, waxes, antioxidants, functionalized polyolefins, oils, and combinations thereof, in addition to the low molecular polyolefin prepared according to the process and/or prepared in the system disclosed herein.

The term “tackifier” is used herein to refer to an agent that allows the polymer of the composition to be more adhesive by improving wetting during the application. Tackifiers may be produced from petroleum-derived hydrocarbons and monomers of feedstock including tall oil and other polyterpene or resin sources. Tackifying agents are added to give tack to the adhesive and also to modify viscosity. Tack is required in most adhesive formulations to allow for proper joining of articles prior to the HMA solidifying. Useful commercial available tackifiers include the Escorez™ series, available from ExxonMobil Chemical.

The term “wax” is used herein to refer to a substance that tweaks the overall viscosity of the adhesive composition. The primary function of wax is to control the set time and cohesion of the adhesive system. Adhesive compositions of the present invention may comprise paraffin (petroleum) waxes and microcrystalline waxes. In embodiments, the adhesive compositions of the present invention may comprise no wax. In embodiments, waxes may be used with the polymer blends of the invention including, but not limited to, Castor Oil derivatives (HCO-waxes), ethylene co-terpolymers, Fisher-Tropsch waxes, microcrystalline, paraffin, polyolefin modified, and polyolefin.

The term “antioxidant” is used herein to refer to high molecular weight hindered phenols and multifunctional phenols. Antioxidants that may be used with the polymer blends of the invention, including, but are not limited to amines, hydroquinones, phenolics, phosphites, and thioester antioxidants.

The term “oil” or “plasticizer” is used herein to refer to a substance that improves the fluidity of a material.

The term “functionalized polyolefin” is used herein to refer to maleic anhydride-modified polypropylene and maleic anhydride-modified polypropylene wax.

While the present invention has been described and illustrated by reference to particular embodiments, those of ordinary skill in the art will appreciate that the invention lends itself to variations not necessarily illustrated herein. For this reason, then, reference should be made solely to the appended claims for purposes of determining the true scope of the present invention.

Certain embodiments and features have been described using a set of numerical upper limits and a set of numerical lower limits. It should be appreciated that ranges from any lower limit to any upper limit are contemplated unless otherwise indicated. Certain lower limits, upper limits, and ranges appear in one or more claims below. All numerical values are “about” or “approximately” the indicated value, and take into account experimental error and variations that would be expected by a person having ordinary skill in the art.

To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

### EXAMPLES

To demonstrate the efficiency of the filter 60, the percent of polymer removed from the polymer solution was evaluated. Referring back to FIG. 1, the cooling medium 6 used was liquid propylene. The polymer solution 2, having a propylene-ethylene polyolefin and isohexane as solvent, was cooled to a temperature of 40° C. in the heat exchanger 20 to form a cooled polymer solution 4. The inventors discovered that for this polymerization process, 0.06 lb (27.2 g) of polymer accumulated in the internal equipment leads to fouling.

The solvent 8 flow rate, solvent 8 polymer concentration, and time between cleaning was recorded to calculate the percent of polymer removed from the polymer solution. The results are reported in Table 1.

TABLE 1

| Time | | | Polymer |
|---|---|---|---|
| since last | Solvent 8 | Solvent 8 | Removed |
| Filter Basket | Flow Rate | Polymer | from Polymer |
| Cleaning | (lb/hr; | Concentration | Solution |
| (hr) | kg/hr) | (ppmw) | (%) |
| 78.5 | 262; 118.8 | 2,550 | 99.9 |
| 50.8 | 195; 88.5 | 8200 | 99.9 |
| 11.3 | 193; 87.5 | 10,300 | 99.7 |
| 15.8 | 164; 74.4 | 10,700 | 99.8 |

The results of Table 1 indicate that the filter 60 efficiently removes polymer from the polymer solution, thereby reducing the fouling of internal equipment.

1. A process for producing a low molecular weight polyolefin adhesive component, the process comprising:
(a) cooling a polymer solution to a temperature less than or equal to about its cloud point to form a cooled polymer solution;
(b) filtering the cooled polymer solution using a filter;
wherein the polymer solution comprises a low molecular weight polyolefin adhesive component and a solvent; and
(c) recovering the solvent and the polyolefin.

2. The process claim 1, wherein the polymer solution has a cloud point of greater than about −50° C. to less than about 40° C.

3. The process of claim 1, wherein the filter comprises a basket, and wherein a cooling medium passes through the basket.

4. The process of claim 3, wherein the cooling medium is selected from at least one of liquid propylene, ethylene, glycol, and freon, and wherein the cooling medium has a temperature of about −28° C. to about 10° C.

5. The process of claim 1, wherein the solvent is a hydrocarbon solvent selected from at least one of isohexane and n-hexane.

6. The process of claim 1, wherein the polyolefin has a weight average molecular weight of from about 1,000 g/mol to about 200,000 g/mol.

7. The process of claim 1, wherein the polyolefin has a melt viscosity of about 80 cP to about 500 cP.

8. The process of claim 3, wherein the filter basket has openings with a diameter of about 0.1 to about 10 microns.

9. A low molecular weight polyolefin prepared by the process of claim 1, wherein the polyolefin comprises (a) a first propylene-based polymer, wherein the first propylene-based polymer is a homopolymer of propylene or a copolymer of propylene and ethylene or a C₄ to C₁₀ alpha-olefin; and (b) a second propylene-based polymer, wherein the second propylene-based polymer is a homopolymer of propylene or a copolymer of propylene and ethylene or a C₄ to C₁₀ alpha-olefin; wherein the second propylene-based polymer is different than the first propylene-based polymer; wherein the polymer blend has a melt viscosity of about 1,000 cP to about 20,000 cP at 190° C.

10. An adhesive comprising the low molecular weight polyolefin of claim 9.

11. The adhesive of claim 10, further comprising one or more adhesive components, selected from at least one of a tackifier, wax, antioxidant, functionalized polyolefin, oil, plasticizers, and combinations thereof.

12. The adhesive of claim 10, further comprising one or more polar polyolefins, selected from at least one of ethylene vinyl acetate, ethylene acrylate, block copolymer, propylene homopolymer, ethylene homopolymer, amorphous poly-alpha olefin, and combinations thereof.
